(19) United States
(12) Patent Application Publication
(10) Pub. No.: US 2013/0181385 A1
(43) Pub. Date: Jul. 18, 2013

(54) LOG YOKE OR CUP

(71) Applicant: Richard Bowness, Cumbria (GB)

(72) Inventor: Richard Bowness, Cumbria (GB)

(21) Appl. No.: 13/823,168

(22) PCT Filed: Jul. 10, 2012
(86) PCT No.: PCT/GB12/51628

§ 371 Date: Mar. 14, 2013

(30) Foreign Application Priority Data
Jul. 13, 2011 (GB) 1112036.7

(51) Int. Cl. B25H 1/06

(52) U.S. Cl. CPC B25H 1/06
USPC 269/13

(57) ABSTRACT

A workpiece support features a plurality of yokes (11) with respective jaws, cups or throats (13,17), set upon a common support beam (18); with provision for yoke tilt to one side of the beam for contents discharge; for log cutting, stacked logs could be segmented by successive cuts between yokes, with severed logs in each yoke being retained in a cluster, such as for side tipping into a bag or sack (78).

This invention relates to workpiece mounting and support, with stands, racks, cradles, trestles, saw horses, benches, and associated props, jigs and fixtures.

A particular role arises with otherwise cumbersome and so awkward to handle elongate irregular profile workpieces, such as tree trunks or logs which are not completely straight, for cutting into shorter log lengths, typically for ease of transport and storage for burning, possibly after further splitting.

Workpiece restraint and support for disciplined working, such as cutting, slicing and severing, is desirable. A cut generally squarely across a log section is desirable for a shorter cutting path.

A high level or even workshop standard of security and stability in support and retention is desirable on site, or out in the field, without the cost and complexity of workshop machines. Health and Safety considerations apply for working operatives. Thus the workpiece should not accidentally fall out or tip over once loaded by a tool, but nevertheless should be readily releasable once work is completed.

The size, and in particular cut span of logs is conveniently set for conformity with a target end use; such as simply the breadth capacity of a stove or furnace in which logs are to be consumed by burning.

It is desirable to support workpieces, such as individual or multiple stacked logs, with minimal interference to cutting through at a target position; and with support preserved both before and after cutting, so cut pieces are retained until released, so they cannot fall randomly on the ground and constitute a user stumble or trip hazard. The discharge of cut logs should conveniently be coherent and controllable.

A facility to (bag) pack and/or wrap cut logs upon severance from a source trunk would save time and effort.

### PRIOR ART

Both general-purpose and bespoke trestle and saw horse forms are known for support purposes. Trestles have a long history as rigid supports for load bearing, location and restraint. Trestle support is commonly at opposite ends of a workpiece. Traditionally or historically trestles were of timber, latterly of metal, synthetic resin, plastics and even concrete. Adaptations for special purposes have been devised. So-called saw horses are one such specialised trestle form. Commonly, a horizontal beam is supported at opposite end corners upon splayed and usually braced legs.

Collapse-fold multiple leg variants are known, as are mutually complementary nesting or stackable profiles. Adjustable height beams and folding legs have also been devised, in metal and plastics. In a wider context of jigs and fixtures, workpiece location and retention elements of diverse format are known, commonly for mounting upon a bench, stand or merely legs. Log cutting can be undertaken manually using a coarse tooth log saw blade or powered using a chain saw with a series of fast-moving fine teeth. In either case, log cutting can be a hazardous task, especially upon break-through severance into two independent pieces, with risk of back strain in holding, balancing and restraining a cutting tool and a workpiece, before and after cutting.

Adaptability to cutting out in the field' at a mobile portable workstation near the source of felled timber and/or at permanent workshop station is desirable.

A conventional approach to timber, trunk or log support is reflected in log saw horses, of which a diversity of configurations are known; commonly a folding splayed open-lattice grid leg ‘X’ frame to create a locating ‘V’ throat upstand upon splayed legs when erected.

Simpler known crossed stilt leg trestles are not well suited to cutting a stack of timber of irregular sized and contour. Logs are liable to jump about or snag a saw bladed when a saw is applied. Cut timber is allowed to fall randomly on to the ground, creating a user stumble or trip hazard, particularly undesirable when the user is carrying an active chain saw. Fallen cut lugs have to be laboriously picked up from where they have fallen, collected together and taken to a store or transport point.

Collapse-fold or scissor-fold crossed-leg trestles are known.

Elongate ‘V’ section panel trough formats have also been proposed with a chain saw support mounting and/or with a blade shroud at one end, such as a ‘free’ outboard overhanging end cutter.

Generally, no provision is made for confining, collecting, containing or organising sawn cut logs when released, let alone ‘bagging’ or wrapping in a disciplined coherent fashion, so these just lie about on the ground around the cutting area, creating a floor tripping hazard.

Operationally, the exposed metal frame can come into contact with a saw blade, with risk of blade and frame damage; and attendant reduced cutting efficiency or an abbreviated or abortive cut.

A common general-purpose collapse fold saw horse format has splayed legs, creating an upper V-shaped throat and a lower triangulated braced leg support. In some versions a horizontal sacrificial beam is supported on at opposite ends. Simple chain saw supports, such as sheaths, are also known, as are workpiece yoke clamp frames, chain restraints and ties. An adjustable incremental span multiple juxtaposed log support posts with cradles is known; including a protective sacrificial timber inset fillet upon a horizontal metal base frame, such as per web link http://www.stihlpowertools.co.uk/

An alternative, albeit rather fanciful ,approach to multiple log cutting of upright stanchions surmounted by U-shaped yoke box framing is reflected in U.S. Pat. No. 4,437,368.

However, these do not provide the more ‘complete’ or rounded solution sought by the Applicant for rapid, safe log cutting. A challenge is to contrive a minimal economic robust compact construction, without limitation or compromise on functionality. Also one admitting flexible mounting configuration, whether on legs or stands, or attachment to other handling machines, such as excavator buckets or lift/handling tines.

### STATEMENT OF INVENTION

A co-operative array of workpiece support yokes

(de-) mountable upon a common support beam

and movable thereupon for workpiece displacement.

The beam itself could be carried upon a trestle,

conveniently of adjustable height.

A linear series of mutually-aligned yokes or yoke throats

allows long workpiece capture at successive staged positions,

which can selected to suit task demand diversity.

Yoke spacing can be fixed or adjustable.

A simple screw fastener or clamp yoke mounting might be used for beam attachment.

A workpiece support yoke,

configured as a open top trough or cup

to receive, locate and retain one or more workpieces

to be subject to work action;

and with a movable mounting

for yoke and contents displacement.

A yoke side pivot mounting would allow yoke tip over

for contents discharge, to one side and below.

A trough cross-section could splayed,

such as with one or more outwardly canted or sloping sides,

for workpiece load stacking and stack discharge.

A workpiece support yoke (11)

with a throat (13) for workpiece reception on one side

and mounting throat (17) on another, say opposite, side,

disposed in mutually co-operative juxtaposition upon a support.

Yoke width conveniently reflects a target cut log breadth or span.

A fixed-format yoke is convenient and economical for manufacture. That said, a variable format, or adjustable ‘throat’ capacity yoke could be contrived, say to accommodate a greater range and/or diversity of workpiece content.

A yoke could be a former for bagging cut log contents by sliding a bag, wrap or sleeve over the yoke while still full of cut logs; then tipping over the loaded yoke to discharge the loose log contents into the bag.

Consideration is desirably given in yoke sectional profile to cutting approach angle, such as the ‘ramp’ inclination or slope of an abutment face for a chain saw front body, in order to facilitate or optimise the cutting action. The saw can be worked against the leading yoke face in a rocking action to promote cut progression without undue pressure or the saw teeth baulking at or jamming in the workpiece.

Yoke stability is desirable for workpiece cutting, but yoke mobility after cutting is convenient for ‘porting’ cut workpieces.

A movable retaining element could be fitted to a yoke,

such as across the top mouth,

and optionally down and/or around the sides,

to help keep otherwise loose stacked contents in place for working upon.

A provision for tie wrap of contents,

to retain stack or bundle integrity after cutting into pieces,

could feature yoke side wall apertures or slots

to feed through tie bands or wires

underneath a stack and then brought up and around the stack.

For ease of storage and transport,

yoke sections could usefully allow interesting

in a compact stable stack array.

A segmented or fragmented yoke construction

allowing selective break off and severance

from a contiguous row,

rather in the manner of a confectionary bar or tablet,

could be contrived,

most readily with an integral plastics moulded construction,

using thin wall joint sections between yoke portions.

An individual yoke could have a stand-alone role, rather like a local mounting, location, retention or support element, or more usefully, in combination with other yokes in a co-operative, say linear, array for an extended elongate workpiece support before and after working. Slide locking wedge inserts could fit between workpiece and yoke sides

A convenient yoke mounting could be a clamp bracket, this could serve for each of a series of yokes upon a common support beam extending under and in between successive yokes. The beam itself, or rather its outer faces, can serve as a relatively soft sacrificial element, with a saw allowed to cut into it locally at the end of a workpiece cutting stroke, to ensure clean-through workpiece penetration without saw tooth or sides damage. A timber beam or outer cladding suffices for this purpose. Reference markings or indicia could be applied to the beam as a visual cutting line and/or depth local or proximity reference with optional measurement gradations. The beam itself could be mounted, say secured with screw clamps, on proprietary end stands, such as tripod legs, (axle) stands or trestles. A traditional timber saw horse with transverse beams and splayed legs at opposite ends might suffice for multiple yoke support.

A clip-on edge protection strip could be fitted to the yoke panel sides for saw tooth protection. This to supplement or substitute for panel face protection covers. Aside from bespoke plastics moulded sheaths or cover plates, deep slots could be cut in the edges of timber sheets, particularly of thick plywood, to receive metal panel bodies.

A minimal workpiece local support,

could comprise a yoke with an upper throat, for workpiece reception,

and a lower throat for support (beam) mounting.

A multiple spaced yoke array,

could be configured for local workpiece confinement and/or support at intervals,

with intervening spacing for freedom of working,

such as through-cutting.

A workpiece mounting, carriage or support,

such as one configured as, or to stand upon, a trestle, bench or saw horse,

with one or more (re-)movable workpiece yokes (11)

mountable in mutually co-operative juxtaposition

upon an underlying support beam or carriage frame (18).

In a particular construction,

a plurality of juxtaposed yokes or yoke pieces

with respective profiled open-sided, relatively outwardly splayed throats or jaws, is set at a span corresponding to a desired workpiece sub-division or segmentation.

A work support, stand, trestle or bench for a workpiece,

such as a tree trunk, branch or timber log,

with multiple juxtaposed yokes,

allows local workpiece access or exposure,

for a work task, such as a series of spaced cuts to subdivide the workpiece, whilst preserving individual workpiece segment disposition and overall support.

In one construction, multiple juxtaposed workpiece segment capture and location yokes, with ‘U’ or ‘V’ profile throats, are set upon a common underpinning support or carriage beam. Conveniently, the yokes are hinged or pivot mounted, to allow contents discharge, such as (up and) over to one side. Yokes could be demountable for ease of adjustable positioning and spacing upon the beam. Yoke bases could be of complementary (throat capture) profile to the beam, for flexible snap-on or clip-on fitting. A folded or CNC pressed sheet metal yoke construction lends itself to this.

Yokes could be captive to and/or mutually entrained with a common support beam through a linear-rotational interactive coupling; say with a yoke follower traversing an index path in the beam.

A demountable and/or collapsible, splayed corner leg, braced trestle format is convenient, but can be inflexible in addressing workpiece diversity. A triangulated or tripod stand can be adopted for stability.

A movable, such as rotatable, throat or yoke allows workpiece content displacement. This could also clear access to an underlying sacrificial beam for use as a general-purpose support or saw trestle. A hinge or pivot mounting of a yoke to a beam would allow relative movement to this end. A laterally offset yoke pivot from a throat and underlying support beam centre line allows the yoke to clear the beam when tilted and part rotated. Alternatively, a demountable, say snap-on or clip-on, yoke could suffice. Another configuration would be a reversible or invertible yoke upon beam assembly. An over-folding/over-centre saddle clamp for saw mounting might be contrived, for co-operative overlay/inter-fit with a log yoke or V-throat; and might also serve for log restraint during cutting. CNC press-tooling could help keep sheet metal fabrication costs down for the yoke plates; with a complementary inter-nesting/stacking profile for compact K.D. transport and storage. Yokes are conveniently a continuous metal sheet fabrication, but alternatively open formats providing equivalent full span support might be adopted, such as folded wire lattice or mesh. A challenge is a worthwhile practical advantage, without undue cost penalty; say, rational-incremental, rather than disconcertingly radical.

A yoke could be embraced at the bottom and sides by a folded sheet metal sheath upon a bottom plate secured to a support bear; with a hinge at one lower side edge to allow wholesale tip over of the yoke, about the bottom plate, to the side of the hinge axis.

The hinge can be to one side of the support beam, say at a beam side edge or more outboard of the beam for greater tip over offset from the beam.

A fabricated construction could feature a folded metal sheet frame with external hinge, lined with recycled plastics cladding sheet, with generous protruding edge overlap for protection to cutting saw edges.

A more bespoke construction could be an integral moulding of synthetic plastics material with a through hinge pin joint between interfitting yoke elements.

A ‘bagger’ variant could feature deeper yokes for greater capacity, with tip over to fill a bag once contents have been severed.

A supplementary sideways mobility of yoke mounting would allow separation of otherwise closely nestled yokes for bag or sleeve fitment and removal along with individual yoke tip to discharge cut contents into an overlaid bag.

Different support beam profiles can be utilised, such as a more wide shallow plank section. The support beam could be part of, or carried by a trestle, such as an adjustable height builders style beam on spaced legs.

The lead or approach face of a yoke is desirably set an optimum contact abutment angle for a chain saw front face so the saw can be worked down logs stacked in the yoke for more effective cutting action.

In a tall or deep throated yoke configuration

a yoke tilt hinge or pivot could be located

part way up one yoke side wall

to allow tip-over from a position above the base.

Thus, say, a mid-set side hinge would allow wholesale yoke fold over from and about an intermediate, say circa mid-point, one side.

Yoke inversion would allow contents discharge, say into a pre-fitted bag, sleeve or intermediate loader or load liner chute, over the upper yoke portion.

A load liner chute could be of stiffer, but still flex wall material initially fitted over a yoke after contents cutting and severance from the original log lengths to preface fitment of a bag or sack.

When the loaded yoke is tipped over to one side or inverted with the internal load liner and overlying external sleeve intact the contents fall into the load liner.

The load liner usefully protrudes further from the bag and can then be withdrawn, leaving the cut log workpiece contents within the bag. The liner helps smooth the contents transfer into the bag and reduces the risk of inadvertent spillage.

A closure tie, such as a drawstring, is usefully provided at the mouth of the bag, to keep loaded contents in place until required for use.

A common yoke support beam could itself be mounted upon a trestle of adjustable height; such as an adaptation of a builders trestle with telescopic posts at opposite ends of a transverse bar.

The support beam section could be wide enough to underlie the entire yoke base and hinged mounting plate footprint.

Mounting to the sides of an excavator bucket or to the tines of a fork lift truck or tele handler can be achieved by adaptation of the mounting frame for the yoke support beam

A side mounting for trailer side tipping could also be contrived.

A moulded yoke could supplement or substitute a fabricated construction of discrete metal and plastics sheet or plate elements. Thus, say, a yoke could be a unitary moulded trough, of synthetic plastics material, with a lower side edge hinge mount.

The hinge could connect with a mounting and support element for an underlying support beam. This beam mounting element could also be of a unitary moulded synthetic plastics, with a complementary hinge plate and a hinge pin of metal or plastics.

An integral ‘live’ hinge, such as of a thinner or waisted section mutually entrained jointing or coupling strip, might also be contrived between yoke and mounting elements.

Yoke width can reflect cutting span. A range of different yoke widths could be specified to address various target cut lug sizes.

With a moulded yoke, width change could be achieved by selective mould tool or flow path shut-off in a common tool body or housing.

Corresponding or different span yoke could share a common support beam as required by mix of cut output.

Similarly, with uniform or different, fixed or adjustable, spacing between successive adjacent yokes.

A minimalist yoke format could feature an open lattice or matrix frame.

A restraint tie cord, strap, band or web could bridge between the respective upper edges of opposite sides of a yoke, so at each side of a workpiece load.

The restraint might usefully have a twofold role of inhibiting workpiece movement while being worked up, such as during cutting; and also to keep the contents confined with the yoke internal throat confines until read for discharge at or after yoke tip over.

### Embodiments

There now follows a description of some particular embodiments of the invention, by way of example only, with reference to the accompanying diagrammatic and schematic drawings, in which:

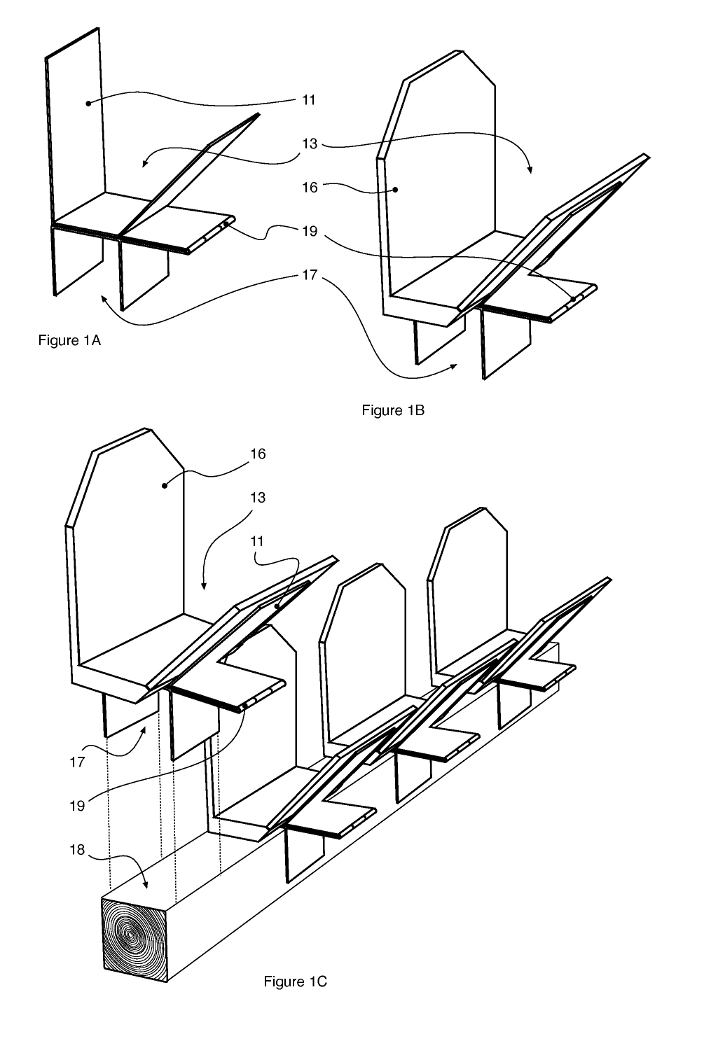

FIGS. 1A-1C show yokes, cups or troughs 11, for workpiece (not shown) capture, location, retention and support, demountable upon a common timber mounting or carrier support beam 18 shown in FIG. 1C; the beam 18 could be ‘sacrificial’ to allow occasional or inadvertent cuts without saw tooth damage; in this example an offset hinge pivot is depicted, but the hinge disposition admits of variation, to lie within or at the boundaries of the yoke base plate;

More specifically:

FIG. 1A shows a 3-D perspective view of a yoke 11 with two, upper and lower mutually hinged throat, jaw or cup parts, 13, 17, closed together in a workpiece support configuration, so that an upper part 13 sits upon a lower part 17, with respective hinge plates in mutual abutment, with outboard or laterally offset hinge pivot or hinge pin 19;

FIG. 1B shows a variant of FIG. 1A fitted with protective yoke liner cover plates or sheaths 16;

FIG. 1C shows an array of yokes 11 set upright upon a common support beam 18, conveniently a readily available rectangular section timber fence post;

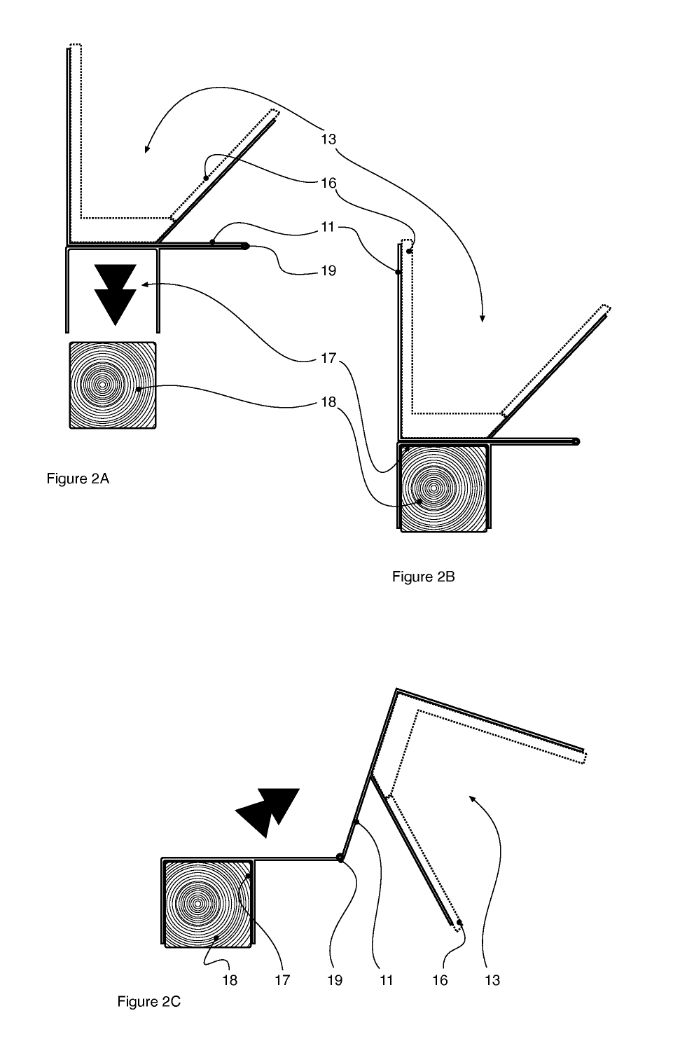

FIGS. 2A-2C show installation of the yokes 11 of FIGS. 1A-C upon a support beam 18 and swing or tip over upper yoke 13 swing or tip for contents discharge laterally and below;

More specifically:

FIG. 2A shows a side elevation of the lined yoke 11 of FIG. 1B; with lower yoke throat 17 juxtaposed with an underlying support beam 18;

FIG. 2B shows a subsequent installation stage to FIG. 2A, with yoke 11 fitted to beam 18 by snug capture by lower throat 17;

FIG. 2C shows the beam mounted yoke 11 of FIG. 2B with upper throat 13 swung over about offset pivot 19 away from lower throat 17 and tipped over to one side and hang downwards in discharge mode; some form of travel limit abutment stop or restraint chain (not shown) may be employed to limit such yoke 11 splay and throat travel and help preserve lateral stability;

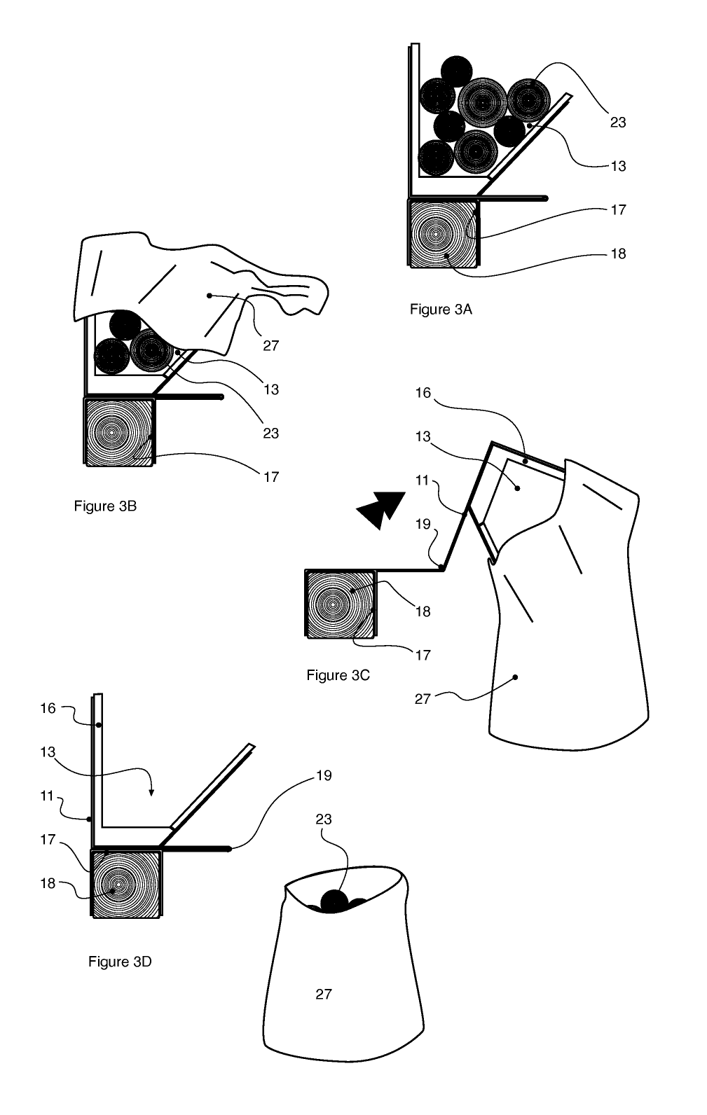

FIGS. 3A-3D show yoke loading and rotational tip-over discharge for bagging collection;

More specifically:

FIG. 3A shows a loose cluster of small logs 23 accumulated in the upper throats 13 of one or more yokes 11, ready for or after cutting into segments of the width or span of each yoke 11;

FIG. 3B shows a containment bag or sack 27 deployed over an individual yoke throat 13 along with its contents;

FIG. 3C shows tipping of an individual yoke throat 13 to discharge its former contents 23 into an entrained bag 27 around the throat periphery;

FIG. 3D shows a bagged log outcome, with yoke 11 restored to an upright condition;

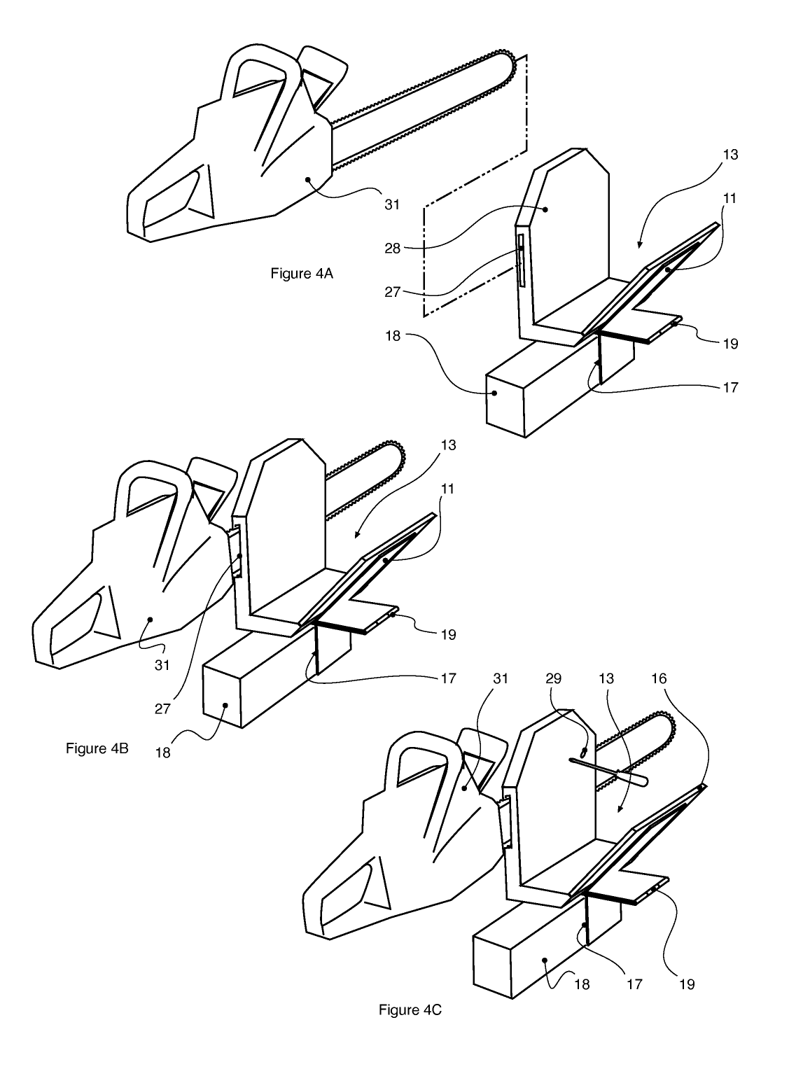

FIGS. 4A-4C show yoke saw mounting, such as for saw tooth sharpening;

More specifically:

FIG. 4A shows a motorised chain saw 31 juxtaposed with a mounting stand 28 fitted to a yoke 11;

FIG. 4B shows a successive mounting step to FIG. 4A, with the blade of chain saw 31 inserted into a side throat in the mounting 28; the insertion depth is sufficient for (counter-balanced) support of the overall saw body and motor;

FIG. 4C shows sharpening of the mounted saw 31 of FIG. 4B using aside access aperture or portal 29 in the mounting 28 and file guidance jig or fixture;

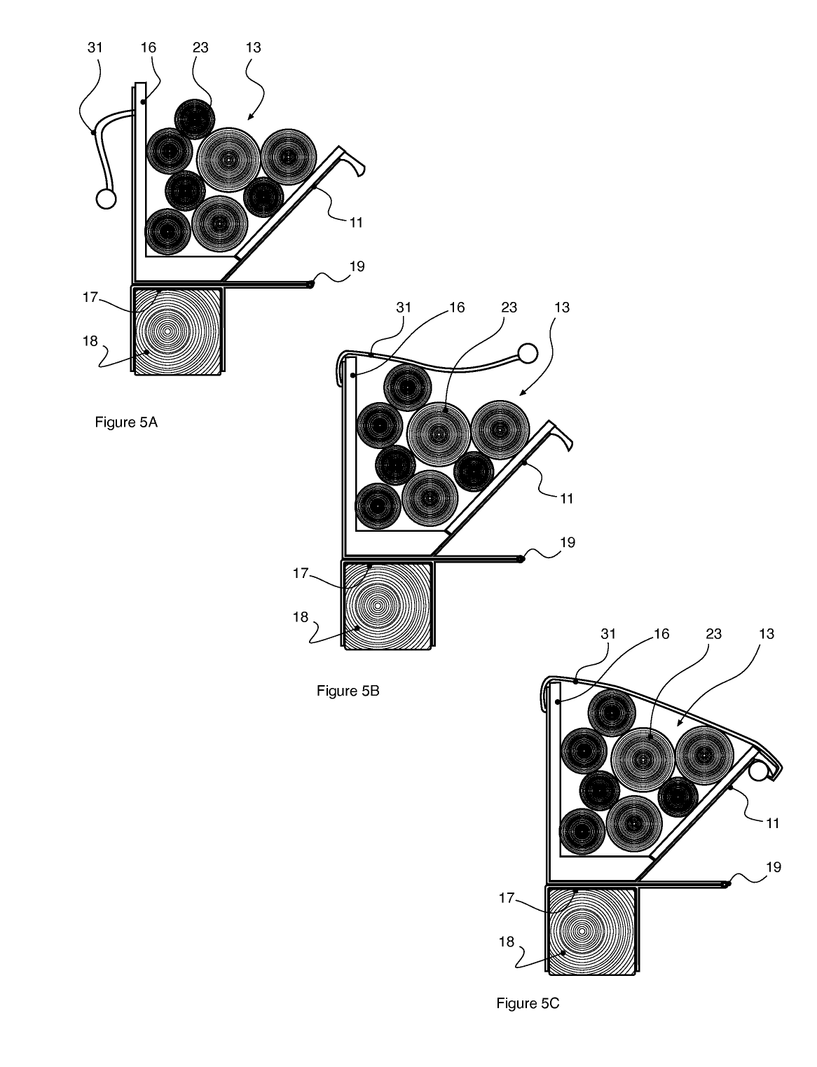

FIGS. 5A-5C shows on board restraint for multiple discrete workpieces clustered in a yoke throat;

More specifically:

FIG. 5A shows a loose log cluster load in upper throat 13 of a yoke 11, with a restraint cord or tie dangling freely down the front face of a yoke plate;

FIG. 5B shows the restraint tie 31 of FIG. 5A deployed by stretching over the load cluster;

FIG. 5C shows the restraint tie drawn across the throat 13 and secured at its outer end with a toggle latch arrangement;

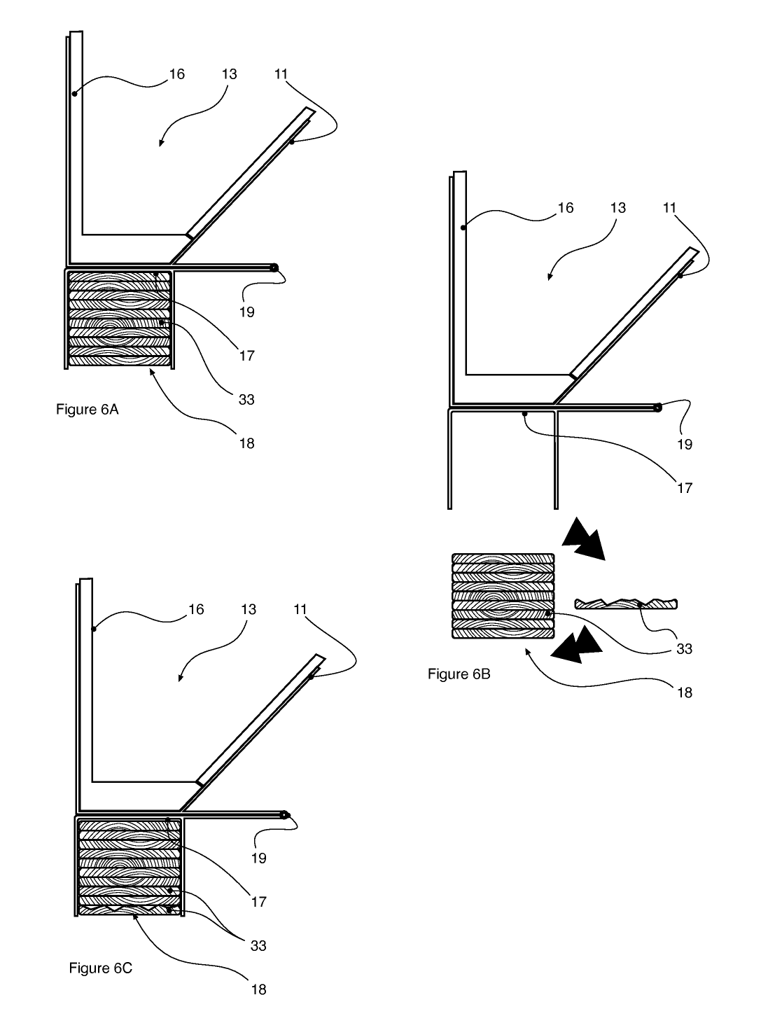

FIGS. 6A-6C show a laminated sacrificial beam for interchange of worn constituent elements in the form of stacked or tiered laminations 33 (re-)movable to present a fresh surface;

More specifically:

FIG. 6A shows a side elevation of a yoke 11 with lower throat 17 mounted upon a laminated beam 33; laminations are constrained laterally by the throat sides and vertically by under trestle support and the throat upper side;

FIG. 6B shows a yoke 11 lifted upwards to release the laminated beam 18 and in turn to allow removal or shuffling of individual laminations 33, such as to present a ‘fresh’ lamination as a replacement sacrificial layer to the top of the stack;

FIG. 6C shows the yoke 11 replaced upon the laminated beam 18 re-shuffled into another lamination stack sequence;

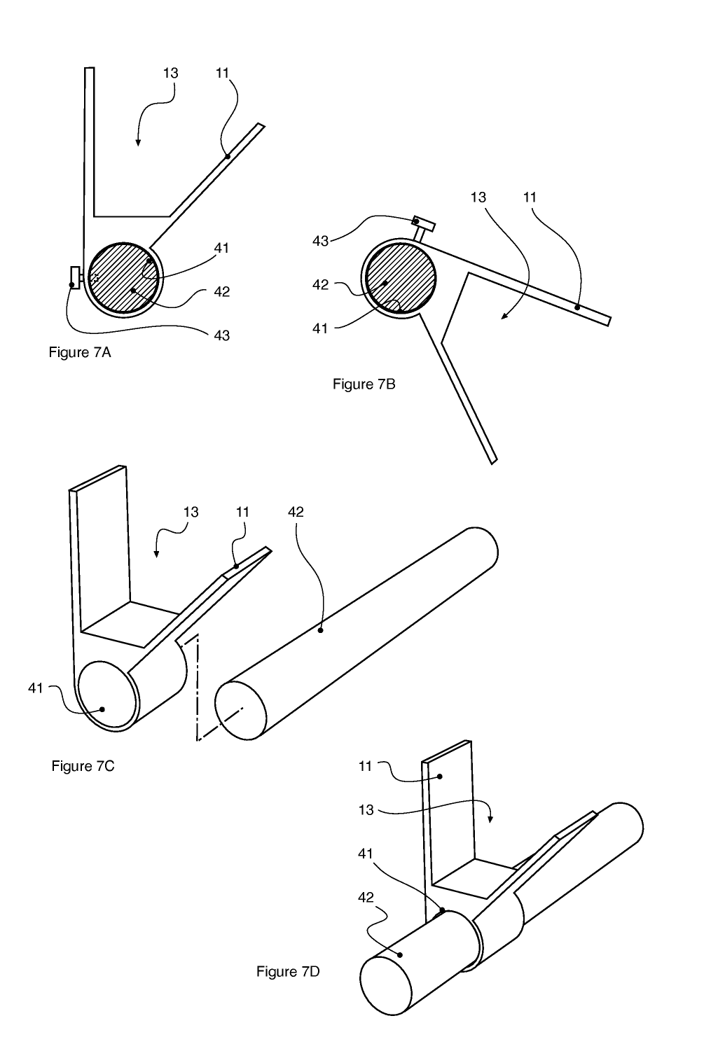

FIGS. 7A-7D show a yoke tube 41 ‘captive’ upon a solid or hollow metal tube beam 42;

More specifically:

FIG. 7A shows a yoke 11 with a single upper throat 13 surmounting a tube body 41 located upon a hollow tube 42, with a side locking screw operable to lock the tube body collar 41 to the internal tube beam 42;

FIG. 7B shows a yoke 11 released from tube 42 engagement with locking screw 43 undone; to allow relative rotation and longitudinal sliding of the yoke 11 upon the tube 42 for yoke (re-)positioning and contents (not shown) discharge;

FIG. 7C shows a juxtaposed yoke 11 and beam tube 42 for mutual alignment and fitment of one upon the other;

FIG. 7D shows a subsequent yoke fitment or installation stage to FIG. 7C, with a yoke 11 located upon a tube 42, received in collar 41;

FIGS. 8A-8D show an translational and rotational indexed yoke beam variant of FIGS. 7A-7D;

More specifically:

FIG. 8A shows a 3-D perspective view of a pair of yokes 11 fitted upon a common bear tube 51 with a profiled surface slot or groove 51 to serve as a guide path or track for an internal follower (not shown) such as the stub lock screw 43 of FIGS. 7A-D;

FIG. 8B shows the tube 41 alone, with a longitudinally-spaced pair of tracks 51 for respective yokes 11;

FIG. 8C shows yokes 11 fitted to the common or shared tube 41 with engagement members (not visible) located in their respective tracks 51; and initial linear slide action is represented by a double-headed arrow;

FIG. 8D show a subsequent step in yoke 11 movement, with relative rotation of yokes 11 for contents (not shown) discharge mode;

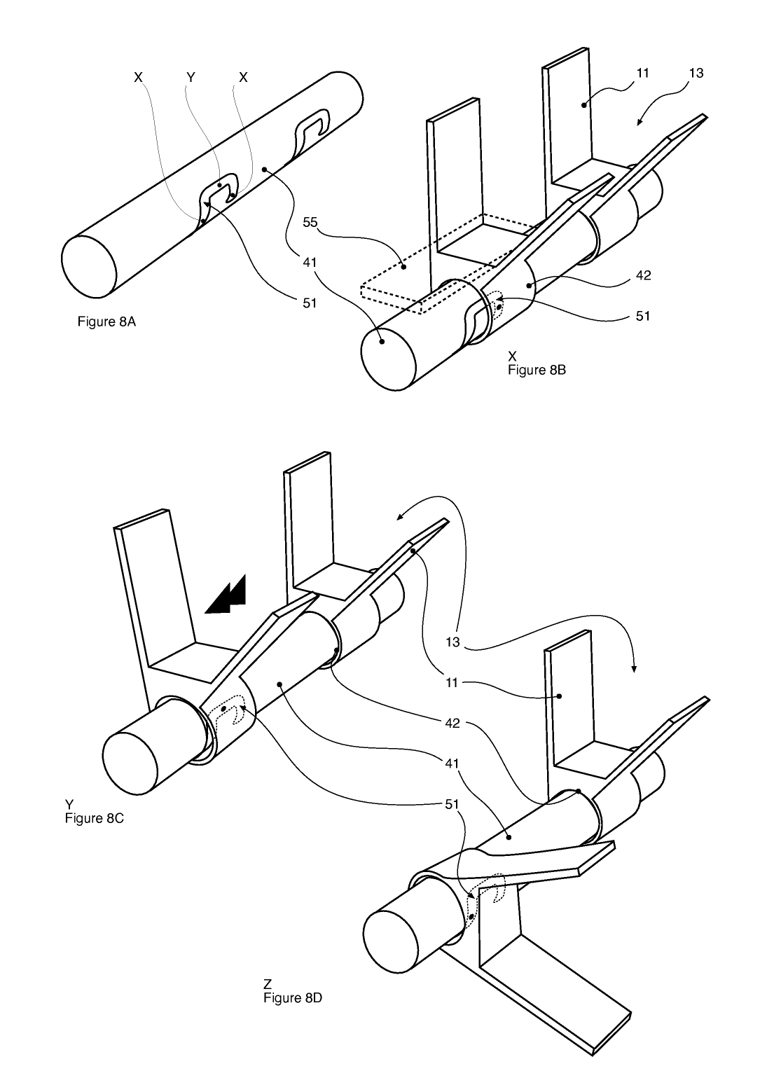

FIGS. 9A-9C show a translational and rotational stepped profile yoke beam variant of FIGS. 8A-8D;

More specifically:

FIG. 9A shows a yoke 11 with a depending rectangular profile location, retention and mounting collar 58 juxtaposed with a profiled support beam 42;

FIG. 9B shows a series of yokes 11 of FIG. 9A mounted at spaced intervals in longitudinal succession upon a profiled beam 42, with respective collars 58 located upon corresponding rectangular section lands of the beam 42; once so positioned the yokes 11 are set at a fixed angular disposition relative to the beam 42, that is they cannot be rotated, unless slide longitudinally to one side so that a collar 58 is transposed to a cylindrical barrel portion 57, as depicted in FIG. 3C;

FIG. 9C shows an individual yoke 11 slid longitudinally along a beam 42, as indicated by a double-headed arrow, until its collar 58 is disengaged from an associated rectangular beam land 50, to allow yoke rotation, as indicated by a diagonal curved arrow, for contents discharge (not shown); the yokes 11 mount or release independently from the beam 42 simply by incremental linear translation;

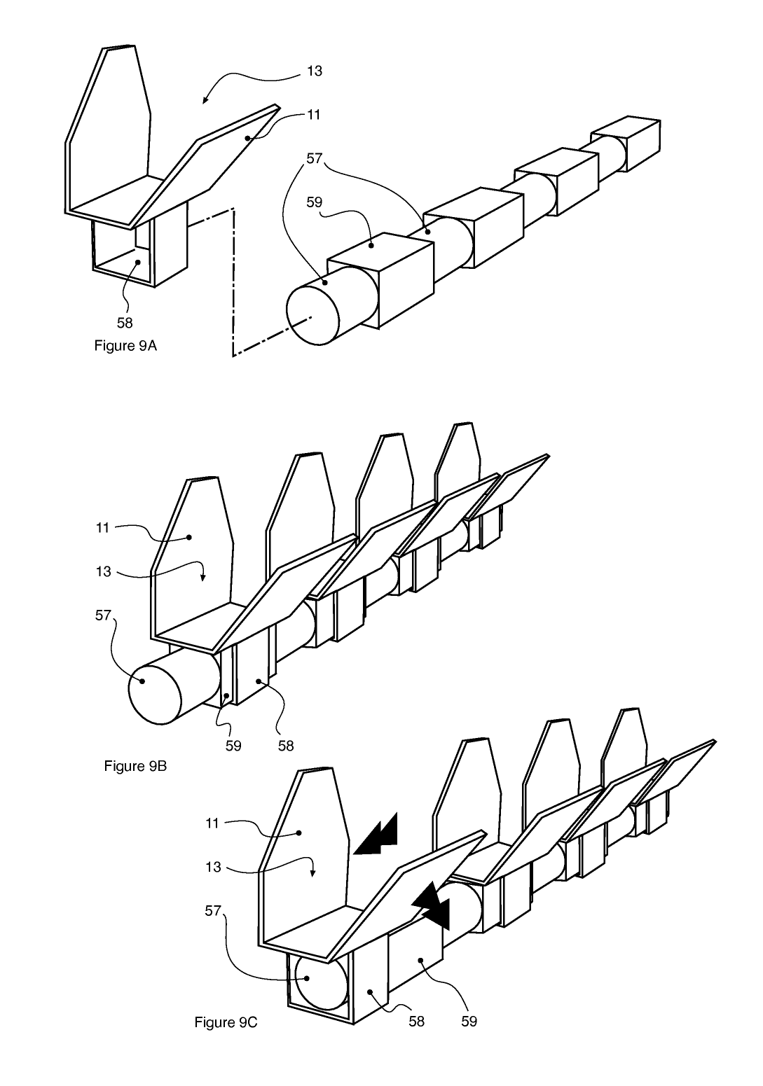

FIGS. 10A and 10B show a stout, gusset-reinforced, hinged yoke fabricated plate construction, for heavy duty use, such as large section tree trunks, and compatible with agricultural and forestry equipment such as tele-handler or fork-lift excavator bucket top sides;

More specifically:

FIG. 10A shows a three-quarter perspective 3D view of a yoke fabricated from heavy gauge metal plate, in a ‘V’-trough format with an outer side brace upstand plate from a hinge upper base plate and internal cross-piece rod elements at a throat internal apex;

FIG. 10B shows the hinge of FIG. 10A split into upper and lower elements with hinge pivot pin interconnection;

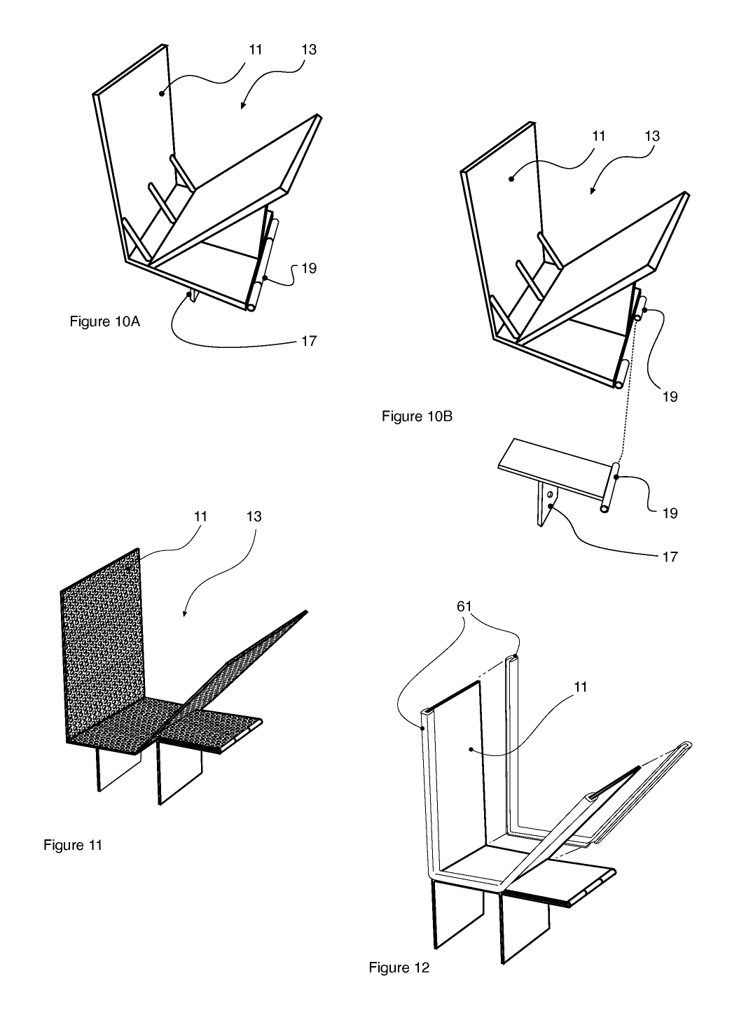

FIG. 11 shows a perforated mesh panel alternative to a solid plate infill;

FIG. 12 shows demountable edge strip, clip-on, protectors 61 for a yoke sides, to substitute for or supplement face plate covers; for saw blade protection;

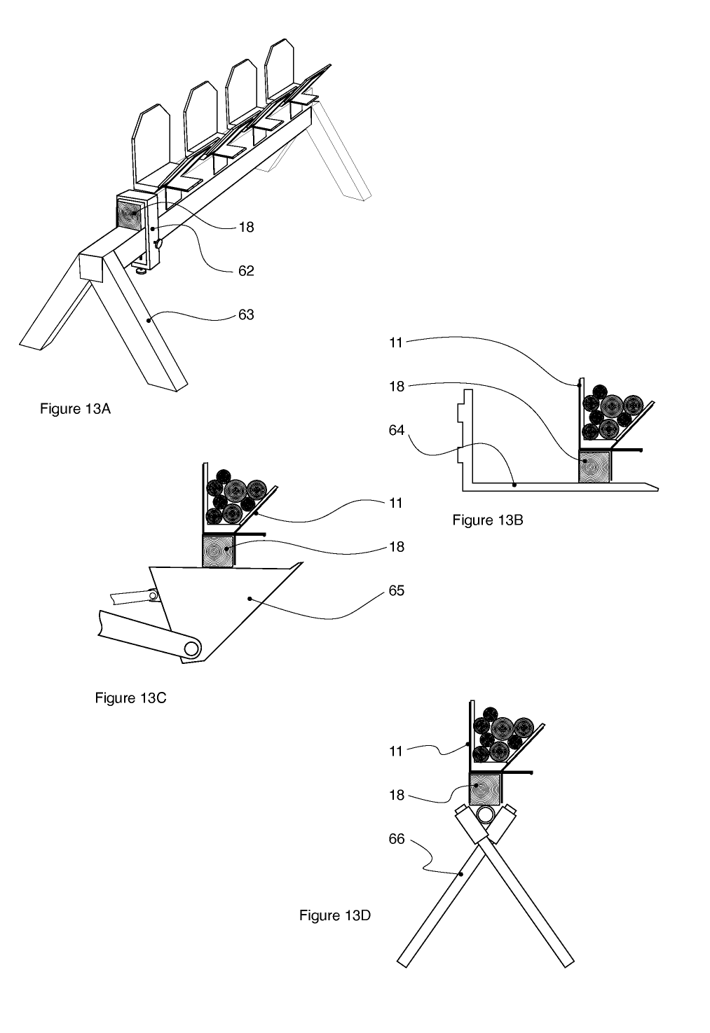

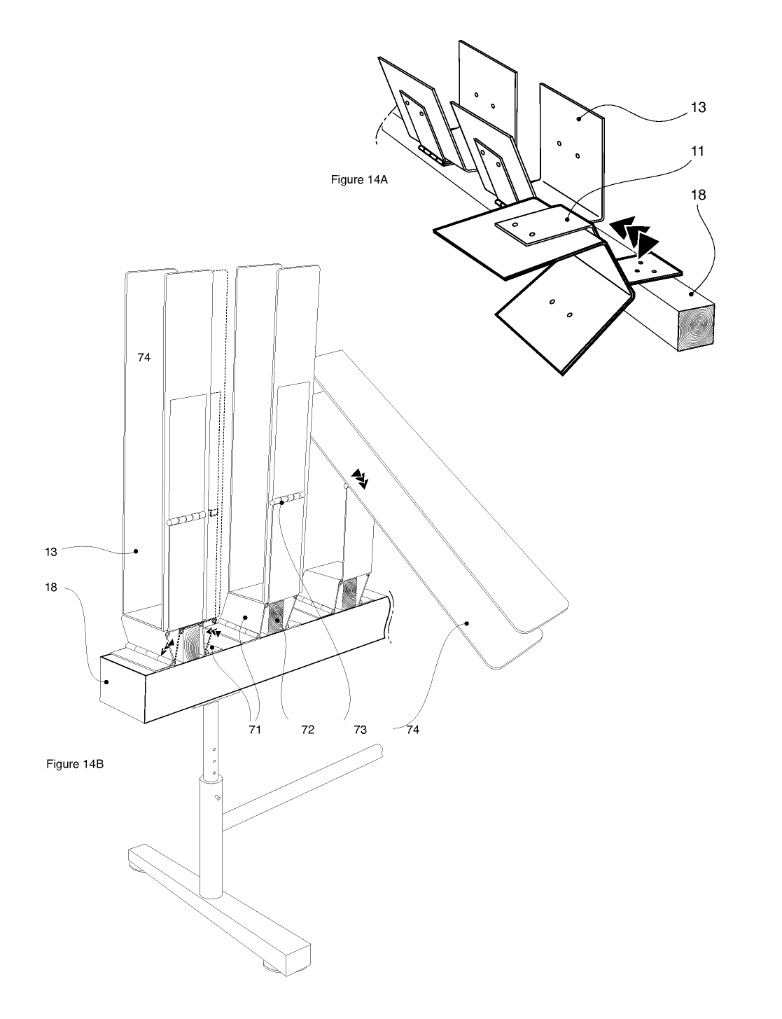

FIGS. 13A through 13D show various yoke and yoke beam support mountings;

More specifically:

FIG. 13A shows a 3-D perspective view of a trestle with splayed legs 63 at opposite ends of a spine secured by clamps 62 beneath a sacrificial yoke support beam 18, set upon a spine of a trestle with splayed legs at opposite ends;

FIG. 13B shows a side elevation of a lift tine 64 support; twin throat location collars (not shown) could fit over the tines and ends of the yoke mounting beam;

FIG. 13C shows a side elevation of an excavator bucket 65 top edge support, so cut workpiece segments (not shown) can be tipped direct from tilted yokes to fall freely into the bucket mouth;

FIG. 13D shows a side elevation of a cross-over leg saddle trestle support;

FIG. 14A shows a 3D perspective view of a more laterally compact form of yoke and yoke mounting with underlying support plate and hinge pivot immediately to one bottom side edge;

FIG. 14B shows a 3D perspective view of a taller ‘bagger’ variant with deep yoke configuration and side hinge intermediate the side depth, along with a bottom double-sided saddle hinge;

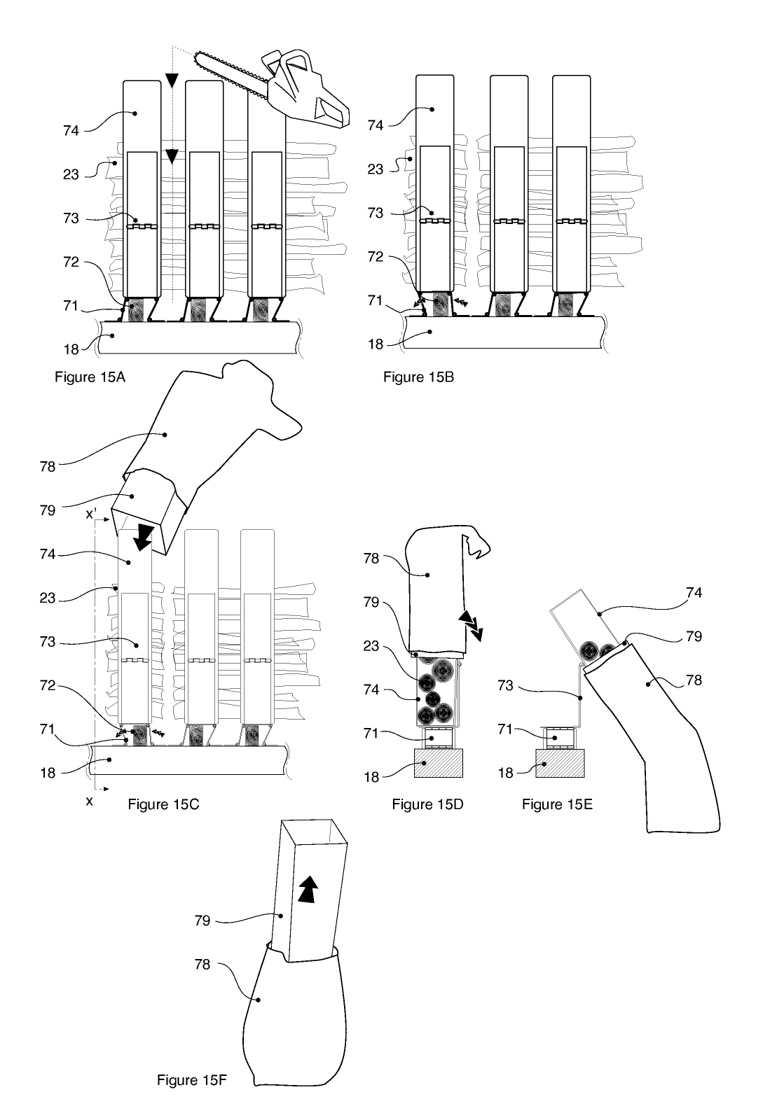

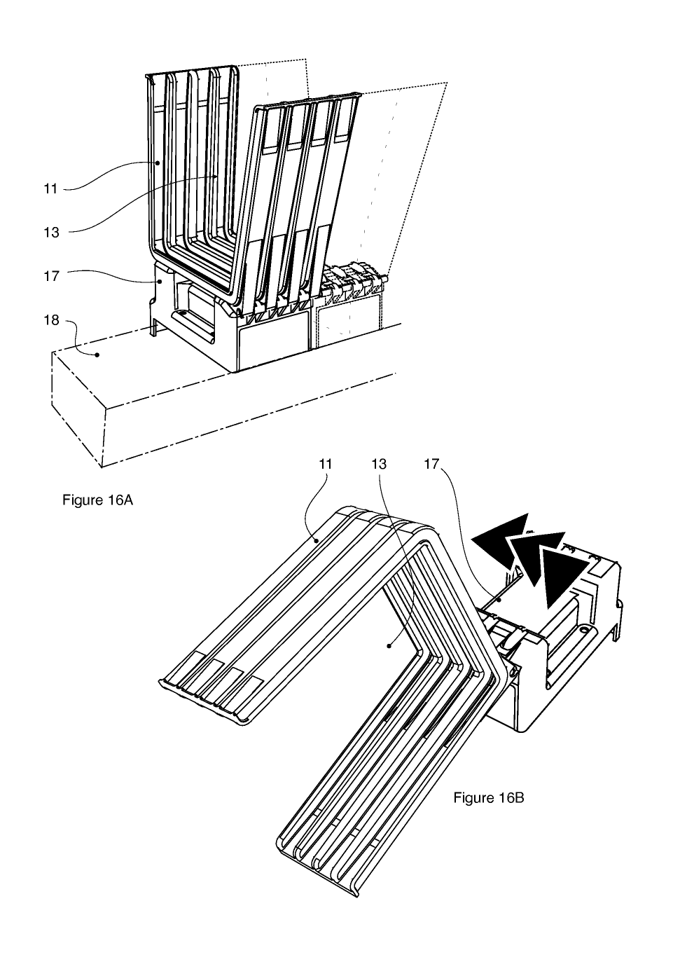

FIGS. 15A through 15F show successive operational stages of the bagger variant of FIG. 14B;

FIG. 16A shows a 3-D perspective view of the moulded synthetic plastics yoke and base saddle with bottom side hinge coupling to a mounting saddle for a support beam;

FIG. 16B shows an individual moulded yoke of FIG. 16A in a tilted over condition about a respective base saddle;

Referring to the drawings, a series of mutually-spaced yokes in a linear array are filled with elongate mixed log trunk loads, and saw cuts made at the intervals between yokes to sever the logs into a series of cut log stacks within individual yokes. This allows rapid disciplined generation of chopped logs, but which are retained in a coherent form, ready for collection.

Generally, the yoke 11 width or span and/or depth admit of considerable variation, to suit an intended workpiece and/or work task, of which cutting is a prime example; similarly yokes of different span could be fitted to a common support beam; yokes could be selectively conjoin or inter-couple for joint or collective movement; a joint strip or band could be used to link and fasten together otherwise independent yokes. A minimal, say folded, wire or rod yoke format could suit some workpiece handling and working tasks. A stippled, ribbed, serrated or even spiked throat internal throat face could bolster workpiece grip or purchase. Yoke throat profile also admits of considerable variation including general purpose or load contour bespoke forms. Whilst flat throat side faces are convenient for manufacture, segmented polygonal or curvilinear forms or a mixed profile could be used better to suit a curved load section. Similarly, tiered or staged yoke side profiles could help retain otherwise undisciplined mixed loads. Opposite mutually splayed yoke sides might co-operate to grip an intervening inserted workpiece, say in the manner of a spring clip. That said, loose fit loads are more readily introduced and discharged upon yoke tilt or inversion. Temporary retention, pending yoke discharge, of a workpiece segment after cutting can be achieved with diverse such variations on the theme.

For the profiled support beam, such as of FIG. 9 sequence, other flat sided polygonal local sectional forms could be adopted rather than just simply rectangular. With a complementary polygonal yoke collar profile, a yoke could be mounted in different angular dispositions to present and locate a loaded workpieces at a convenient working disposition. A multiple element, say laminated, beam admits of (re-)assembly in different forms with different profile or ordering of elements.

Referring to the drawings, a workpiece yoke 11 features mutually hinged upper and lower cup, jaw or throat portions 13, 17 respectively, mutually interconnected by a hinge or pivot 19, which can be removable to allow separation. The lower throat 17 forms a saddle to receive and locate upon a support beam 18, conveniently a stock rectangular section timber post. Alternatively, a simple flat plate profile reliant upon (say screw) fasteners could serve for the bottom hinge. In either case the hinge is extended laterally to present an offset pivot 19, which allows the upper throat 13 to swing over to an inverted condition and to discharge contents clear of the beam 18, as depicted in FIGS. 2C and 3C.

The yoke 11 is conveniently a metal plate fabrication of welded pieces or a CNC press tool pressing of a thinner gauge sheet. A recycled synthetic plastics moulding is another option. A demountable cladding or liner 16, such as plywood sheet or a plastics moulding sheath is fitted to the side walls of the upper throat 13. A series of similar yokes 11 is fitted in mutual (linear) alignment upon the beam 18, so as collectively to form an elongate, subdivided or segmented trough for one or more workpieces, such an informally stacked loose cluster of logs 23 as shown in FIG. 3A, or a large section individual trunk (not shown). Yokes can be individually fastened permanently to the beam 18, such as by screws or bolts, or left demountable with a snug tight friction grip upon the sides of the beam 18. Alternative mutually ‘threaded’ yoke and beam tube arrangement is shown in FIGS. 7 through 9. The overall length of the beam 18 and the associated number of yokes 11 can be varied to suit the work task and situation. An extendable beam, such as a telescopic metal frame with a timber sheath could be contrived. The beam 18 can be mounted variously, such as upon trestles or directly upon other machines, such as an excavator bucket or lift tines of a fork lift truck or telescopic handler.

A prime use for a beam 18 and fitted yoke 11 array is as a saw horse, for cutting, chopping or severing in an agricultural, horticultural or forestry context or merely for light personal domestic use. The rationale is an orderly support and retention of workpiece elements before and after cutting along with an orchestrated and targeted discharge for collection and storage.

Operationally, an elongate workpiece is set in the aligned upper throats of multiple yokes 11 and can be worked upon while in such a shared or distributed support. For a cutting operation, to sever a workpiece, such as a trunk or branch, into a series of shorter lengths, the severed workpieces segments are retained in situ by the yokes 11 or rather the yoke upper throats 13 in which they sit, with the spacing intervals between yokes 11 being sufficient for through passage, with ample lateral or side clearance of a saw blade, such as a chain saw. It is desirable to avoid saw tooth contact with metal yoke sides or beam support and consequent mutual damage; hence the value of a sacrificial beam face material such as timber, whether solid or laminations as in the FIG. 6 sequence. A side edge cover 61 option is also depicted in FIG. 12.

A particular yoke 11 upper throat 13 profile features an upright (front) face and an opposite rearwardly canted (rear) face viewed from the perspective of a user armed with a chain saw and facing the yoke array, beam and support trestle or the like. The upright face can interact with a chain saw body and serve as a cutting depth reference, travel limit, restraint or guide complementary to a comfortable cutting stroke action. The rear face allows a workpiece to lie somewhat away from a saw travel and primed for discharge after severance upon yoke 11 tipping for discharge to the rear side and downwards.

As depicted in FIG. 2A, the underside throat 17 of the yoke 11 is conveniently a snug lift-off fit upon the beam 18. The lateral (rearward) offset of the hinge pivot 19 is sufficient to bring the upper throat 13 clear to one (rearward) side of the beam 18 for contents discharge, as depicted in FIG. 2C. An end upstand in the hinge body profile can enhance hinge element separation upon relative pivot of entrained hinge portions.

Loading of the upper throat 13 with a cluster of modest or small diameter logs or branches 23 is followed by cutting the cluster into segments by passing a saw blade successively through each gap or slot spacing interval between yokes 11. A severed cluster within an individual yoke span, or indeed more that a single yoke, is covered with an inverted collection bag or sack 27, as depicted in FIG. 3B. Tipping over and inversion of the or each yoke 11 while the bag mouth is stretched across the throat 13 between front and rear yoke plates, allows the severed cluster to fall into the bag for removal, as depicted in FIGS. 3C and 3D, whereupon the yoke 11 can be returned to its upright condition ready to receive the next workpiece load. The bagging operation is optional and instead severed workpieces can be discharged direct into a hopper or the like (not shown).

A chain saw is a potential operational hazard, to counter which special protective shroud or sheath 28 mounting provision can be made, as in FIGS. 4A-4C. FIG. 4A shows a demountable saw holster or scabbard 28 as a slip-over moulding for the front yoke plate upstand. A side access aperture 27 leads to a slot in the holster body, allowing a saw blade to sit alongside the yoke 11 and protrude from one end with a portal window 29 to allow individual blade tooth sharpening as depicted in FIG. 4B.

As depicted in FIGS. 5A-5C, a flexible restraint tensioner tie 31, such as an elasticated bungey cord, strap or harness, can be fitted to one (say, front) yoke plate, deployable to stretch over the upper throat, 13 to latch into or over the rear yoke plate, to overlie otherwise loose and disparate yoke contents. A wider, stretch web (not shown, but similar action when viewed from one side or in section) could be employed to envelop a greater longitudinal span of yoke contents or adjacent yoke contents.

A beam 18 refinement is depicted in FIGS. 6A-6C, with an orderly stack of mutually superimposed or successively overlaid or layered laminations 33, whose stack order can be shuffled to present a fresh (upper beam) face to a saw cutter, once an uppermost lamination has been worn or eroded by cutting action. This allows a saw user to slice cleanly through a workpiece depth span, with a clear exit, with a more comfortable saw action than stopping short to preserve beam integrity.

A more interactive yoke and beam configuration is reflected in FIGS. 7A through 7D, with a circular beam tube 42 and a complementary mounting bore 41 in a single-throat yoke 11 rotatable about the tube 42 upon release of a radial grub locking screw 43 in the lower throat body. Thus, for workpiece reception and working upon, the yoke 11 can be locked upright with the screw 43 tightened on to the tube 42 body.

With the screw 43 released, the yoke is free to swing around and hang downwards from the tube 42 to allow contents gravity discharge.

A refinement of yoke and beam tube capture is reflected in FIGS. 8A through 8D, with a dog-leg profiled track 51 to present a dog-leg guide path of successive portions ‘X’ and ‘Y’ for a follower nose (not shown) of an inward projection from the yoke bore. The interaction of follower and guide path 51 allows a yoke 11 to slide longitudinally by tracking pathway groove ‘Y’ along the beam in a locked or rotation-inhibit mode, between rotational stations at which the yoke 11 can rotate about the tube 42 by tracking part circumferential pathway groove ‘X’ and swing around to hang down for tipped over or inverted yoke contents discharge. A sacrificial fillet piece 55 can be inserted in the throat of yoke 11.

A variant of a single-throat yoke 11 and captive beam tube 42 is depicted in FIGS. 9A through 9C, with a rectangular depending yoke under-collar 58 locatable as a snug retention fit upon a complementary rectangular local tube section 59 in a locked upright captive condition, for workpiece contents loading and retention while working, with intervening round section tube 57 to allow yoke 11 rotation through clearance within the collar 58. A simple longitudinal slide action suffices to move a yoke between locked an unlocked whilst still captive modes upon beam 42.

FIGS. 14A though 16B reflect still more elaborate variants. Thus FIGS. 16A, 16B depict a more integrated structure of lighter weight synthetic plastics material that a dual metal sheath and dense recycled plastics liner fabricated approach. FIG. 14A reflects a more compact side hinge variant of FIG. 1A and companion figures.

Similarly, refinements of FIGS. 14B, 15A-15F for mass contents packing allow a much taller and so deeper capacity stack of logs to be accumulated, again cut through in a single sweep slicing action in the interval between successive adjacent yokes.

A yoke base can straddle, sit squarely upon or astride a support beam width of corresponding sized or can marginally overhang to one or both sides. With the overhang to the hinge side, the yoke can tip over clear of the beam side and hang down largely inverted or until the side of the yoke abuts the beam side edge as a travel limit The elevation of the support beam upon a trestle can be set to allow a container, such as a wheeled bin or barrow to park and move under the tipped over yokes to receive the discharged contents clear of any interference.

A moulded yoke allows integration of bespoke features, without undue on-cost, compared with a fabricated construction; although the latter allows trial and error adaptation.

A so-called ‘bagger’ variant allows far greater individual and collective yoke capacity, albeit is more cumbersome, so suited to prolonged work sessions at a given set-up location. The side hinge intermediate the yoke side wall depth, rather than at a bottom edge of a more compact yoke format, allows an over-centre pivot action with a loaded yoke re-orientated as a side discharged chute, particularly well-suited to bagging.

The provision at the yoke base of a facility for hinging in a sideways shuffle action along the support beam to adjust the relative longitudinal positions of the yokes along the beams allows for a temporary greater asymmetrical relative yoke spacing or clearance for bagging operations than the consistent closer clearance appropriate for cutting paths in between successive adjacent yokes. The facility for temporary greater differential yoke spacing provides room for bag and intermediate loading chute fitment. A transverse kneeling or cushion spacer block beneath the double side base hinge regulates the side-to-side travel while providing yoke base support at each extremity of sideways travel longitudinally of the support beam.

Yoke tilt for contents discharge can be undertaken independently of the longitudinal side-to-side swing or kneel action. The spacing between yokes can be maximised by shuffling successive adjacent yokes mutually away from one another along the beam, This can be effected for individual yokes, adjacent yokes or all yokes on a common support beam. Although illustrated for a fabricated construction this shuffle facility or mobility could be implemented in a moulding. A shuffle hinge is indicated generally by reference 71 and an intervening indexing block by reference 72.

FIG. 15A shows an indicative yoke spacing for intervening cut. FIG. 15B shows a locally increased relative yoke spacing to preface bagging. FIG. 15C shows an initial bagging step by fitting an intermediate guide or location collar over a yoke, with the opposite upper collar end into an empty bag 78. FIG. 15D shows a subsequent step of drawing a loading chute 79 with over-fitted bag 78 progressively down over a yoke 74. FIG. 15E shows sideways tip over and inversion of the loaded yoke 74 with inserted chute 79 and over-fitted bag 78 to discharge the yoke work contents into the bag 78. FIG. 15F shows a final step of withdrawal of chute 79 from a loaded bag 78.

In the moulded plastics variant of FIGS. 16A, 16B a series of local reinforcement and stiffener ribs are incorporated into the yoke walls and used as a bottom side edge hinge for insertion of a through-pin. A base saddle 17 also has local stiffening with a depending edge for support beam location and with holes to receive fasteners, such as screws or bolts, to the support beam.

A plastics yoke moulding is less of a hazard to the cutting teeth of a chain saw should inadvertent contact arise. A yoke support beam might also be of moulded or extruded plastics albeit at likely greater expense than a timber beam.

A packer or spacer slab, say also of timber or plastics, could be interposed between a yoke mounting plate and a support beam, to provide a safety operational cutting stroke travel clearance below the level of a yoke floor for cutting action between adjacent yokes. This helps preserve the integrity of the yoke support beam against cut intrusion which might otherwise undermine the beam integrity.

In a moulded plastics version, the depth of the yoke base carrier saddle could be set to provide such end of cutting travel clearance leeway.

The yoke could carry a workpiece capture and restraint element, such as a movable closure jaw (not shown) carried upon one yoke side and which would come over the workpieces and secure to the opposite yoke side. An elasticated tension tie or restraint strap could supplement or substitute for a rigid or semi-rigid capture member.

A hinge damper could be contrived in, or operative in relation to the hinge or pivot connection between yoke and mounting plate or saddle, to dampen and so discipline the yoke tipping action. Similarly, yoke tipping travel limit abutment could feature in the hinge configuration. A modest spring bias return assist from yoke tilt to upright could help rapid turn around from discharge to refill mode.

A resilient vice- or clamp-action yoke could be contrived, with, say, resiliently deformable or semi-rigid flex, opposite sides serving as deformable opposed jaws for workpiece capture. This could also help in allowing snug yoke stacking and packing interfit in storage and carriage.

An asymmetric yoke jaw cross-section allows a sloping side to accommodate workpiece stacking in an orderly, even nesting, manner and provide a discharged guidance path upon yoke tipping to one side, say away from a user standing for cutting. The user near-side yoke side wall could then have a slope which complemented or guide a saw face, for optimised cutting action.

Yoke arrays upon respective support beams might be disposed in tandem, ie end-to-end, to accommodate very long workpieces, or in parallel for simultaneous side-by-side cutting of workpieces, given a sufficiently long saw blade and operative cutting stroke. The latter would be suited to large scale mechanised operation at a workshop site.

The apparatus examples described and illustrated are not exhaustive. Thus apparatus can be scaled up or down or re-configured to suit target workpieces. For deep and/or wide yokes some form of power assist to yoke tilt action, such as a pneumatic strut, or motorised drive, might be employed.

Aside from yoke tilt about a side hinge, a swivel or gimbal base yoke could allow re-disposition and reorientation of cut, other working stroke or action.

A yoke beam or group of beams, say arranged in a lattice matrix or rectilinear grid array, could be supplemented or substituted by a platform, say with an array of yoke mountings, to allow a diversity of yoke arrays and relative alignments for diverse cutting or other working actions.

In more elaborate mechanised work shop variants, a continual rotary radial spider yoke or circumferentially-spaced, radial throat, spinning rotary yoke array might be contrived; with alternating cut and uni-directional rotate-to-discharge sequence, rather than a bi-directional reciprocating tilt to discharge and return to reload action.

A yoke affords a useful group or sub-group ‘cluster capture’ upon elongate workpiece sub-division by successive cutting. Yokes may operate independently, directly their contents have been severed from the common originating or source workpieces.

For longer clusters with a given yoke array, adjacent yokes may be operated together, in multiple yoke sets, such as in immediately adjacent pairs, without intervening cuts, so the longer workpiece clusters are discharged together by co-ordinated yoke action.

Aside from the workpieces contents, the yokes may be temporarily and adjustably inter-coupled by supplementary ties (not shown).

As an alternative or supplement to individual yoke tip or rotation, a common yoke support beam might itself tip or rotate, say about rotary or end or intermediate carrier bearings,

For greater flexibility of alternative use, yoke walls might be profiled, say with bespoke profiled apertures or top edge grooves or notches, to allow bridging workpiece support between opposed yoke sides, with an intervening cutting clearance of the depth of the yoke throat. Similarly, temporary work platforms or support ledges could be carried on yoke opposite side upper edges.

A ‘bagger’ loading chute 79 might address more than one yoke to feed their respective individual contents in turn collectively into a common bag; or a bag may be loaded successively by using a single chute in turn to unload different yokes.

As a loading guidance intermediary, a chute 79 reduces or obviates snagging of cut load ends upon a bag wall. A sacrificial disposable or re-usable chute might be left in situ for bag unloading. A soft-walled fabric or plastics bag 78 may be substituted by a semi-rigid or flexible walled, say concertina collapse fold holdall of thin-wall plastics sheet or card.

The hinge interconnection between yoke and mounting base may be a snap-action, quick-release, or readily severable, interacting claw and slot, without the need for a separate hinge pin.

A yoke opposed wall upstand and base platform can be continuous infill sheet or panel, or a series of discrete juxtaposed elements, such as spaced ribs, as a grating or grill, allowing unwanted debris to pass in between as self-purging yoke format.

Yoke end wall and/or base edges could be profiled, such as serrated or corrugated with alternating teeth and slots, for selective inter-couple, so mutually edge-engaged yokes can move as a unitary body.

A moulded plastics yoke could have a curvilinear or wavy, rather than strictly rectilinear, wall cross-section profile, to afford workpiece support with minimal local contact to reduce the risk of contents jamming in a yoke throat and resisting free discharge upon tipping.

An adjustable capacity yoke depth could be achieved with folding side wall extensions; say top-hinged and able to in-fold or out-fold to increase wall depth. Thus, until required, a top wall extension panel could lie as an inner liner alongside a yoke outer wall when in-folded about a top hinge; and deployed by out-fold when needed to an abutment stop, readily contrived by having the inner wall extend somewhat beyond the hinge.

Dual yoke requirements of workpiece support both before and after cutting to preserve separation and integrity of severed pieces, along with support beam capture and mounting, whilst allowing yoke tip action, suggest discrete yoke and mounting; not least for ease of fabrication in manufacture; albeit a contiguous format is achievable by unitary moulding with a thin-wall residual connection such as a so-called ‘live’ hinge, which could also impart some return bias against flex, twist or deformation.

A yoke might sit astride or side-saddle of a support beam; that is with a re-entrant or inwardly stepped or notched base profile to receive a support beam cross-section. Such a saddle yoke could be generally symmetrical about the beam. Alternatively, an asymmetric saddle yoke could sit more to one side of a beam that the other. A saddle yoke could either pivot or roll about a, say, mid-set, beam. A segmented or round local beam section could promote complementary rotary inter fit with a saddle yoke. A polygonal yoke step and complementary local beam profile would allow indexed angular positional change while maintaining longitudinal position. A saddle yoke could thus be a continuous profiled element, such as a contoured plate or sheet, whether fabricated, folded or moulded, if necessary with stiffener or reinforcement ribs, although the overall shape and form would itself contribute stiffness.

A cruciform yoke planform would allow elongate load disposition along either of two mutually orthogonal axes, for work task variation.

Overall, a robust, straightforward in use, flexible yoke workpiece retention and support arrangement is available in variant configurations. For user self-assembly, a required number of yokes can be pre-fitted to a shared sacrificial beam, such as a rudimentary stock timber post, itself carried upon diverse supports from trestles to buckets and tines with securing clamps, collars, clips and like fastenings.

### COMPONENT LIST

11 yoke
13 throat
16 cover
17 throat
18 sacrificial beam
18 hinge pivot
23 logs
26 slot
27 bag
28 sheath
29 port
31 saw
32 tie
33 slat
41 collar
42 tube
43 follower
51 groove track
57 cylindrical barrel
58 collar
59 rectangular land
62 clamp
63 splayed leg
64 lift tine
65 bucket
66 cross-over leg stand
71 saddle hinge
72 spacer block
73 side wall hinge
74 deep throat ‘bagger’ yoke
78 bag
79 loader chute

1-23. (canceled)

24. A workpiece support, mounting or carriage, with one or more workpiece yokes (11), movable upon a support (18) for contents discharge.

25. A support of claim 24, with a plurality of mutually aligned yokes, demountable upon a common underlying sacrificial beam (18), with yoke base side hinges for tilt discharge.

26. A support of claim 24, with mutually hinged yoke throat portions (13, 17), an upper portion configured as a splayed wall trough or throat (12) with opposite outwardly canted or sloping sides, for clustered contents stacking and discharge with compact inter-nest and stack for storage and carriage, when demounted.

27. A support of claim 24, with an upper yoke throat portion (13) for workpiece reception and a lower yoke portion (17), such as a mounting plate, for fitment upon an underlying support beam (18), the portions (13, 17) being connected by a laterally-offset hinge or pivot (19), at one side of a yoke base, for offset rotation of the upper portion (13)about the lower portion (17) for contents discharge to one side of and below a support beam (18).

28. A support of claim 24, with an upper yoke throat (13, 17) to receive a workpiece and a lower yoke throat for fitment to an underlying support beam (18).

29. A support of claim 24, with a composite support beam of laminated elements (33), configured as a tightly-packed, re-orderable cluster, to allow transposition and re-location of constituent elements to present a fresh sacrificial upper surface.

30. A support of claim 24, with an open lattice yoke body.

31. A support of claim 24, with a yoke of upper and lower throats (13, 17),with opposite sides co-operatively movable in scissor-fashion interaction, so that as a workpiece is loaded in an upper throat, the beam is gripped in an opposed lower throat.

32. A support of claim 24, with a yoke support beam configured as a hollow metal tube (41)received within a yoke collar (42)with a surface groove (51) tracked by a yoke follower (43)for selective yoke translation or rotation.

33. A support of claim 24, with a yoke support beam carried upon an adjustable height trestle.

34. A support of claim 24, configured for mounting upon lift tines (64),a digger or excavator bucket (65), or an upstanding trailer wall.

35. A support of claim 24, with a supplementary side-shuffle hinge yoke mounting for adjustment of relative yoke spacing.

36. A support of claim 24, with a yoke configured for overlay by a bag or sack, so that upon yoke tip over its contents are discharged into the sack.

37. A support of claim 24, with an intermediate loading chute for insertion in a contents bag, to obviate bag snagging upon log cut ends protruding on each side of a yoke.

38. A support of claim 24, with a yoke as a moulding of synthetic plastics material with integrated stiffening and reinforcement ribs, configured to receive a hinge or pivot for pivotal connection to a moulded carrier saddle to fit upon a support beam.

39. A support of claim 24, with a yoke profiled as a stepped saddle with a re-entrant bottom step or recess to accommodate a support beam for mutual location, but with a round or polygonal complementary interfitting cross-section to allow relative indexed angular position change or rotation.

40. A support of claim 24, configured as a moulding of synthetic plastics material, with a discrete upper yoke for workpiece carriage and an entrained saddle to sit upon a support beam.

41. A support of claim 24, with a movable retaining element fitted to a yoke, such as across the top mouth, and optionally down and/or around the sides, to keep yoke contents in place, with option for tie wrap of yoke contents, to retain stack or bundle integrity after cutting into pieces, comprising yoke side wall apertures or slots to receive and feed tie bands or wires underneath then up and around yoke contents.

42. A support of claim 24, with a deep side wall yoke for enhanced capacity, with an intermediate sidewall hinge to allow yoke tip over well about a yoke base.

43. A support of claim 24, configured as a log saw trestle, for segmentation of a log workpiece, by cuts between successive yokes, and retention of severed pieces within respective yokes, for respective discrete contents discharge.
